(19) United States
(12) Patent Application Publication
(10) Pub. No.: US 2020/0309515 A1
(43) Pub. Date: Oct. 1, 2020

(54) SURVEYING SYSTEMS

(71) Applicant: LEICA GEOSYSTEMS AG, Heerbrugg (CH)

(72) Inventors: Thomas LÜTHI, Aarau (CH); Michael LETTAU, Laufenburg (DE); Albert MARKENDORF, Walde (CH); Marco LÜSCHER, Brugg (CH); Dennis MOOR, Gretzenbach (CH)

(73) Assignee: LEICA GEOSYSTEMS AG, Heerbrugg (CH)

(21) Appl. No.: 16/368,727

(22) Filed: Mar. 28, 2019

(51) Int. Cl. G01B 11/25; H04N 5/247; H04N 5/225; H04N 5/232

(52) U.S. Cl. CPC G01B 11/2518; H04N 5/247; H04N 5/23299; H04N 5/23203; H04N 5/2256

(57) ABSTRACT

A surveying system comprising a global coordinate measuring device (CMD) and a local CMD, wherein the local CMD is configured to coordinatively survey surface survey an object. The surveying system has a coordinate transformation functionality, during the execution of which a first transformation of the local coordinate system of the local CMD into the global coordinate system of the global CMD takes place, whereby at least three reference points, the respective defined position of which is known to either the global or the local CMD, are surveyed by the respective other CMD. A second transformation of the global coordinate system into the object-side coordinate system also takes place, whereby the global CMD surveys at least three support points, the respective defined position of which in the object-side coordinate system is known.

The invention relates to surveying systems and to a surveying method for surveying an object surface.

Surveying systems which are configured to coordinatively determine the position of points on a surface, such as in particular a 6 DoF laser tracker, a total station or a laser scanner, have been known for some time from the prior art.

Such industrial measurement systems record their data in a local instrument-linked reference system. For the particular intended use, said data often have to be transferred into a superordinate reference system. In the prior art, this procedure takes place for example by means of specifically introduced monuments or else natural features which can be clearly defined in both reference systems.

One specific example of such measurement stations is a laser tracker with a camera. For such a laser tracker, a trackable target point at which it is possible to aim with precision is formed by a retroreflecting unit (for example a cube prism or corner cube retroreflector), which is aimed at by an optical laser measurement beam of the measuring device. The laser beam is reflected by the retroreflector back to the measuring device in a parallel manner, the reflected beam being detected by a detection unit of the device. An emitting and receiving direction of the beam is determined for example by means of angle measurement sensors, which are assigned to a deflecting mirror or an aiming unit of the system. Upon detection of the beam, a distance from the measuring device to the retroreflector is additionally determined, for example by interferometry or by measuring the propagation time and/or phase difference or by a FMCW-based measurement method, a WFD method, a frequency comb-assisted measurement of distances, or by an absolute interferometer, in particular a frequency-scanning interferometer.

To this end, laser trackers according to the prior art often have a tracking surface sensor in the form of a position-sensitive surface detector (such as for example a PSD or a CCD or CMOS sensor), wherein measurement laser radiation that is reflected at the target can be detected thereon and a corresponding output signal can be generated. By means of downstream or integrated electronics, the output signal can be evaluated and for example a focal point can be determined. By means of this tracking and precise-aiming sensor, therefore, a tray of the point of impingement (focal point) of the detected beam from a servo control zero point can be determined and, on the basis of the offset, a precise aiming or—in the case of movement—tracking of the laser beam onto the retroreflector can take place. A detection by the tracking and precise-aiming sensor takes place coaxially to the measurement axis, so that the detection direction corresponds to the measurement direction. The tracking and precise aiming can only take place once the measurement laser has been oriented at least roughly towards a retroreflecting target such that the retroreflector is hit by the measurement laser beam (as viewed at least somewhere in the beam cross-section of the measurement laser beam). After the precise aiming, an angle and distance measurement takes place—as described above—for the actual surveying of the retroreflector.

The described target tracking must be preceded by a coupling of the laser beam to the reflector. To this end, the reflector can be manually introduced into the laser beam, either by manually orienting the laser tracker towards the target or by displacing/moving the target into the beam. Also known are embodiments in which an image of the target environment is displayed on a display by means of an optical overview camera and the target or targets is/are marked in the image.

There are also trackers which have an additional detection unit with a position-sensitive sensor and with a relatively large field of view, for example of 10° or 15°, be arranged. Also integrated in generic devices are additional illumination means, by which the target or the reflector is illuminated with a wavelength in the infrared range. In this connection, the sensor may be configured to be sensitive to a range around this particular IR wavelength, in order for example to reduce or to completely inhibit the effects of extraneous light. By means of the illumination means, the target can be illuminated and an image of the target with the illuminated reflector can be captured by the target detection camera. By imaging the specific (wavelength-specific) reflection onto the sensor, the position of the reflection can be resolved in the image and thus an angle relative to the detection direction of the camera and a direction to the target or reflector can be determined. One embodiment of a laser tracker having such a target-seeking unit is known for example from WO 2010/148525 A1. Depending on the direction information that can thus be derived, the orientation of the measurement laser beam can be changed such that a distance between the laser beam and the reflector to which the laser beam is to be coupled is reduced.

Another example of a generic surveying method is 3D scanning. 3D scanning is a very effective technology for producing millions of individual measurement data, in particular 3D coordinates, within minutes or seconds. Typical measurement tasks are the capturing of objects or of surfaces thereof, such as industrial systems, house facades or historical buildings, but also accident sites and crime scenes. Surveying devices with scanning functionality are, for example, total stations and laser scanners such as Leica P20 or Leica Multi Station 50, which are used to measure or to establish 3D coordinates of surfaces. For this purpose, they must be able to guide the measurement beam—usually a laser beam—of a distance measuring device over a surface and thus to detect simultaneously the direction and distance from the respective measurement point at a predefined scanning or measurement rate successively from different measurement directions. In this case, the direction and distance are based on a measurement reference point, such as for example the location or zero point of the surveying device; in other words, these lie in a common reference system or coordinate system, so that the individual measurement directions and thus the individual measurement data are therefore linked to one another via the common measurement reference point. Based on the measured distance value and the measurement direction correlated therewith for each point, a so-called 3D point cloud can thus then be generated from the multitude of scanned points, in particular by means of an external data processing system.

In terms of the basic structure, therefore, such stationary scanners are configured to detect, by means of a telemeter, usually an electrooptical and laser-based telemeter, a distance from an object point as a measurement point. The telemeter may be configured for example according to the principles of time-of-flight (TOF) measurement, phase measurement, waveform digitizer (WFD) measurement, or interferometric measurement. In particular, for fast and accurate scanners, a short measurement time is required while at the same time achieving a high measurement accuracy, for example a distance accuracy in the μm range or below for measurement times for the individual points in the range from sub-microseconds to milliseconds. The measurement range is from a few centimetres to a few kilometres.

A measurement direction deflecting unit which is likewise present is configured such that the measurement beam of the telemeter is deflected in at least two independent spatial directions, that is to say the measurement direction is continuously varied, as a result of which a (partially) spherical spatial measurement area or scanning area can be captured. The scanning area is often 360°, that is to say a full circle, in the horizontal and covers for example a range between 90° and 270° in the vertical, so that for example at least a hemisphere is covered. The scanning resolution with which the scanning area is covered results from the number of measurements or, in other words, the number of measured points per spatial area or spherical surface element. The deflecting unit may be embodied in the form of a moving mirror, or alternatively also by other elements suitable for the controlled angle deflection of optical radiation, such as for example twistable prisms, movable optical fibres, deformable optical components, etc. The measurement usually takes place by determining distance and angles, that is to say in spherical coordinates, which can also be transformed into Cartesian coordinates for display and further processing purposes.

The area to be scanned is currently defined for example by marking the desired corner points on a screen which displays the image from an additionally integrated overview camera. If a visible pointer beam marks the target point, then the area can be selected on a keypad or by remote control, without using a screen.

In all cases, it is desirable to define the respective surveying devices the area to be scanned and the reflector of interest in a manner remote from the operating computer, without touching the device.

In addition, it is desirable to simplify the above-described coordinate transformation from the system-internal reference system to an external, object-based reference system.

The problem addressed by the invention is therefore that of providing an improved surveying system.

This problem is solved by implementing the characterizing features of the independent claim. Features which develop the invention in an alternative or advantageous manner can be found in the dependent claims.

The invention relates to a surveying system comprising a global coordinate measuring device having a global coordinate system, a local coordinate measuring device having a local coordinate system, wherein the local coordinate measuring device is configured to coordinatively survey a surface of an object, in particular by means of fringe projection, so that surveyed surface points exist in the local coordinate system. The global coordinate measuring device and the local coordinate measuring device are connected by means of a common control and evaluation unit.

According to the invention, the control and evaluation unit has a coordinate transformation functionality, during the execution of which first transformation parameters for transforming the local coordinate system into the global coordinate system are determined, whereby at least three reference points, the respective defined position of which is known to either the global or the local coordinate measuring device, are surveyed by the respective other coordinate measuring device, and second transformation parameters for transforming the global coordinate system into the object-side coordinate system are determined, whereby the global coordinate measuring device surveys at least three support points, the respective defined position of which in the object-side coordinate system is known.

Optionally, the at least three reference points are projected by the global coordinate measuring device in a defined manner onto a surface and the projected reference points are surveyed by the local coordinate measuring device, in particular during the coordinative surveying of the object surface. As a further option, the reference points are projected onto the object surface, in particular in a targeted manner onto a location on the object surface which, at the time of projection, lies in the field of view of the local coordinate measuring device on account of the surveying of the object surface taking place simultaneously.

Optionally, the reference points are projected onto a position-sensitive optoelectronic detector of the local coordinate measuring device, in particular wherein the sensitive detector surface occupies substantially the surface area of one housing side of the local coordinate measuring device.

As an option, the at least three reference points are defined points on the housing of the local coordinate measuring device which can be surveyed by the global coordinate measuring device, in particular wherein the points are configured as separate markings, in particular in the form of reflectors or LEDs, on the housing.

As an option, the markings are surveyed by means of a camera and/or by means of measurement radiation of the global coordinate measuring device.

In a further aspect, the invention relates to a surveying system comprising a surveying device configured to coordinatively survey a movable target. The surveying device has a target detection camera with a detector which is sensitive in a defined infrared wavelength range, wherein a direction to the target can be determined by means of the target detection camera on the basis of infrared radiation coming from the target, wherein the target detection camera has a field of view of typically 15°.

The surveying system additionally comprises a laser pointer, spatially separate from the surveying device, for visually marking the target or a target area with visible radiation, wherein according to the invention the laser pointer is configured additionally to mark that target or the target area with radiation in the defined infrared wavelength range such that reflected laser point radiation can be detected by the detector.

As an option, the visible radiation and the infrared radiation can be generated by a common laser source or by in each case a separate laser source of the laser pointer. As a further option, the infrared radiation has a wavelength in the near infrared range, in particular a wavelength of 860 nm.

In one development, the infrared radiation of the laser pointer can be modulated with a first and a second modulation, in particular in the form of pulses of different pulse frequencies, and/or wherein a respective modulation serves to suppress extraneous light and/or to transmit information, for example split such that the suppression of extraneous light takes place by way of the first modulation and the transmission of information takes place by way of the second modulation.

Optionally, the laser pointer has a communication transmitter and the surveying device has a corresponding communication receiver, in particular configured as Bluetooth and/or WLAN modules, and/or provided for initiating by means of the laser pointer a marker radiation detection procedure by the surveying device.

Optionally, the surveying system is configured to issue control commands to the surveying device by means of the infrared radiation, in particular by way of defined radiation pulse patterns and/or symbols which can be decoded by a control and evaluation unit of the surveying device.

In one development, the surveying device has a light source for emitting a directional light beam, and the surveying device is configured such that a detection of a target area marked by the infrared radiation is visually confirmed by a user, whereby the surveying device marks using the visible light steel, in particular whereby the visible laser beam moves over the boundaries of the target area.

Optionally, the surveying device has an overview camera which is sensitive to the visible radiation of the laser pointer, and the surveying device is configured such that a verification of a position determined by the target detection camera and marked by the infrared radiation takes place on the basis of a position determined at the same point in time by the overview camera and marked by the visible radiation.

The invention additionally relates to a method for controlling a surveying device which has a direction and distance measurement functionality, in particular a total station, a laser tracker or laser scanner, wherein the surveying device has a target detection camera with a detector which is sensitive in a defined infrared wavelength range, said camera being configured to determine a direction to the target on the basis of infrared radiation coming from the target, in particular wherein the target detection camera has a field of view of at most 15°.

According to the invention, the surveying device is controlled by means of a laser pointer which is spatially separate from the surveying device and which emits radiation in the defined infrared wavelength range, said radiation being detected by the surveying device by means of the target detection camera and evaluated on the basis of stored control command decoding information.

Optionally, in the context of the method, the control takes place by means of pulse patterns of the infrared laser pointer radiation and/or by using the infrared radiation to project symbols onto a surface, wherein the pulse pattern and/or the symbol encode a control command.

As a further option, a change in orientation of an aiming axis of the surveying device takes place by means of the infrared laser pointer radiation, in particular whereby the aiming axis is pivoted automatically in a manner following a movement of a radiation spot projected onto a target surface.

The invention also relates to a computer program product, which is stored on a machine-readable carrier or is embodied by an electromagnetic wave, for controlling and/or executing the abovementioned method. The computer program product can be run in particular on a control and processing unit of a surveying system according to the invention.

The method according to the invention and the device according to the invention will be described in greater detail below, purely by way of example, on the basis of specific exemplary embodiments which are shown schematically in the drawings, and further advantages of the invention will be discussed. In the drawings:

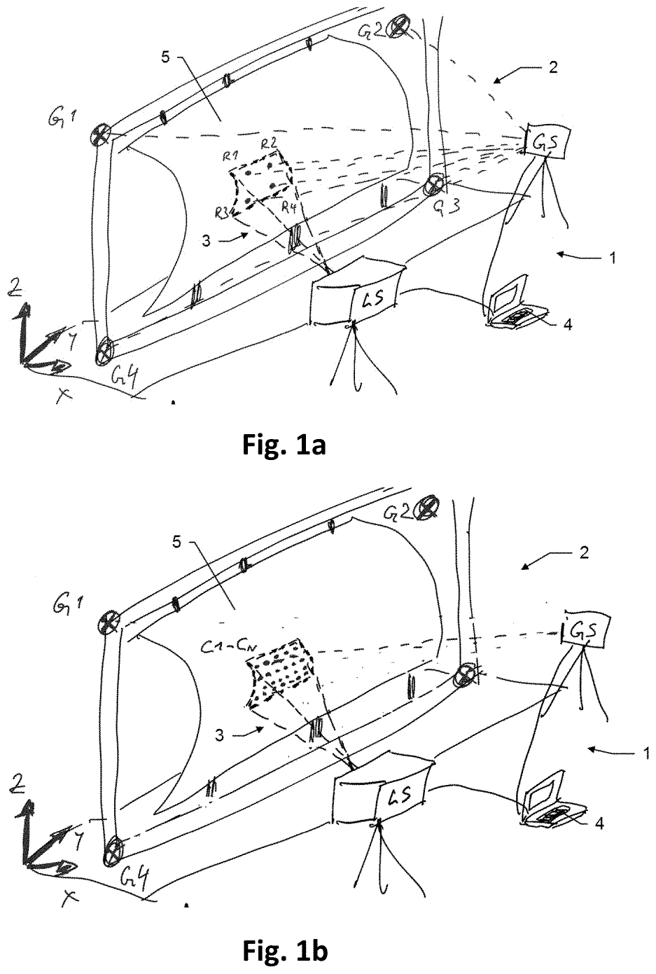

FIGS. 1a,b show first exemplary embodiments of a surveying system according to the invention with a global and local sensor and coordinate transformation;

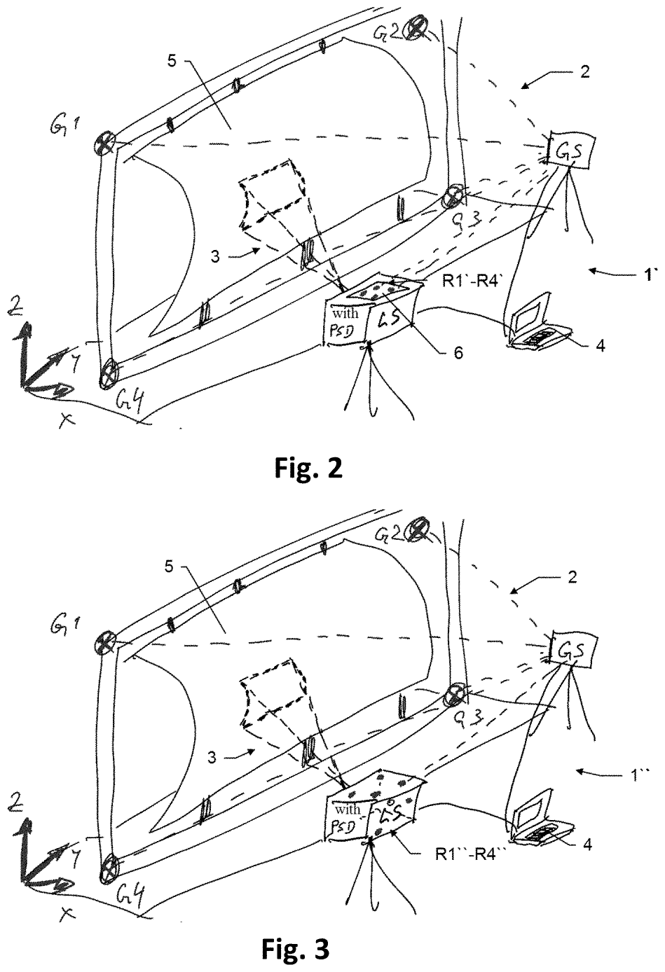

FIG. 2 shows a second exemplary embodiment of a surveying system according to the invention with a global and local sensor and coordinate transformation;

FIG. 3 shows a third exemplary embodiment of a surveying system according to the invention with a global and local sensor and coordinate transformation;

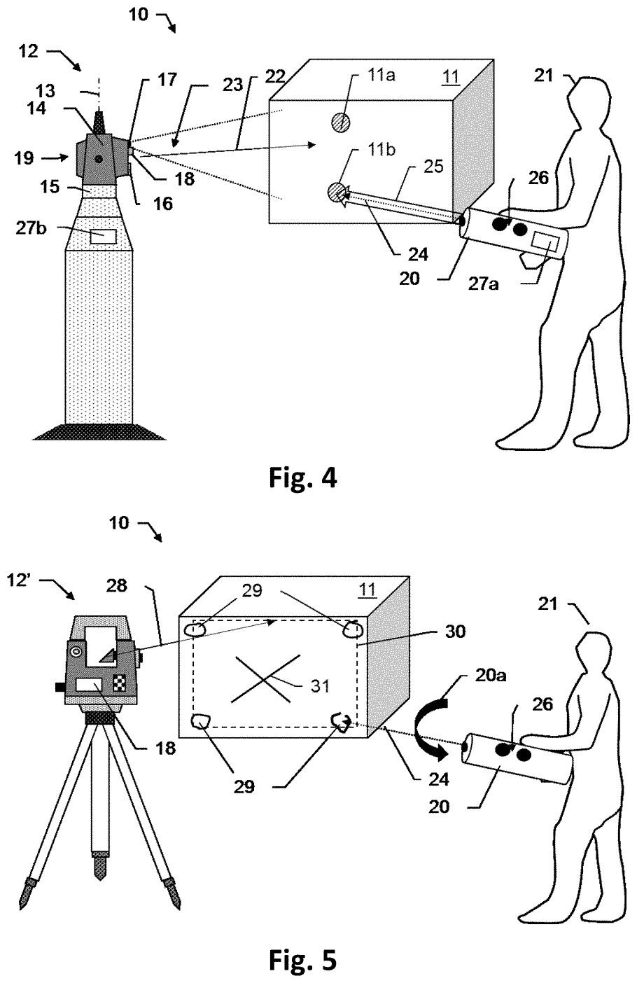

FIG. 4 shows a first embodiment of a surveying system with a surveying device and an IR marker laser pointer; and

FIG. 5 shows a second embodiment of a surveying system with a surveying device and an IR marker laser pointer.

FIG. 1a shows a first exemplary embodiment of a system 1 for industrially surveying an object surface 5, for example an aircraft hull, a car door or another workpiece. The system 1 comprises a global sensor GS, for example a laser tracker, a total station or a laser scanner, and a local sensor LS, which are connected by means of a processing unit or control and evaluation unit 4, in the example a laptop. The global sensor GS and the local sensor LS are therefore connected so as to form a common measurement system 1, so that for example synchronous actuation by the operator can take place using application software on a PC and measurement results from the two sensors GS and LS can be brought together.

The global coordinate measuring device GS detects or surveys, for example by means of measurement radiation 2, points G1, G2, G3 and G4 which are contained in the object-side reference system (symbolized in the drawing by the xyz axis arrows) and which lie for example on the object surface 5. These four points G1-G4 are used to transform the coordinate system (CO system) of the global sensor GS into the object coordinate system. In other words, the sensor-internal CO system can be transformed into the object-side reference system on the basis of the reference points G1-G4, since the necessary transformation parameters are thereby determined.

By means of the local measuring device LS, a surveying 3 of the surface 5 of the object takes place in a manner known per se, for example by means of fringe projection (triangulation measurement using a stripe-like light pattern) or a scan (measuring the direction and distance by means of measurement radiation, for example based on a propagation time measurement or phase measurement), so that a digital point cloud (coordinate list) is produced. In order to be able to carry out a comparison of an individual point cloud (ACTUAL), for example so as to form a design model of the object 5 (TARGET), a coordinate transformation from the system of the local sensor LS to the object coordinate system must take place. In other words, the transformation parameters for this further coordinate transformation must be determined.

In order to achieve this, according to the invention at least three reference points, in the example the four points R1, R2, R3 and R4, are projected onto the surface 5 during the surveying by the global sensor GS, so that said points R1-R4 lie in the field of view of the local sensor LS. These four superordinate points R1-R4 are also detected by the local sensor LS during the surveying, for example along with the detection of the fringe projection or in an image from a camera of the local sensor LS which is located in the internal reference system thereof, so that the camera image and a point cloud, created for example by scanning, can be brought into local correspondence.

Therefore, the four points R1-R4 provided by the global sensor GS and detected by the local sensor LS thus exist in the local coordinate system of the local sensor LS, together with the point cloud representing the object surface 5. Since now the four reference points R1-R4, as a result of being generated by the global sensor GS, also exist in the global reference system and the latter can be transformed into the object-side reference system on the basis of the four points G1-G4, the point cloud created by the local sensor LS can thus be transferred into the object-side reference system.

In other words, the four reference point R1-R4 are transferred by the global sensor GS into the object coordinate system by way of the detected support points G1-G4. Since the reference points R1-R4 are additionally surveyed by the local sensor LS, all the other points of the local CO system of the local sensor LS will also be transformed into the object coordinate system. The point cloud generated by the local sensor LS and representing the object surface 5 can thus be displayed in the “external” CO system, the object coordinate system.

FIG. 1b shows the surveying system 1 according to the invention in use for calibrating the local sensor LS. As an alternative or in addition to the above-described procedure, in this example a much larger number of reference points C1-CN is projected by the global sensor GS into the field of view of the local sensor LS. The number N of such calibrating reference points C1-CN is for example 100 or more, the point density also being increased in comparison to the example shown in FIG. 1a. A relatively large number of points C1-CN can therefore be seen per unit area, these being available to the computer 4 with 3D coordinates in both systems LS and GS.

The distribution and density of the points C1-CN is selected such that calibration parameters of the local sensor LS can thus be determined, for example distortion correction parameters. As an alternative or in addition to an initial determination, a verification of some or all previously determined or existing parameters may also take place, for example in the context of a regular checking of the local sensor LS, after certain events such as, for example, transportation of the measurement system 1 or before the start of any surveying operation.

Optionally multiple passes using the global sensor GS and a large number of measurements using the local sensor LS take place at different orientations of the local sensor LS with respect to the surface 5 or the calibration points C1-CN.

The calibration data from the global sensor GS can take place here as static discrete points and/or as dynamic continuous measurements, the optical system of the global sensor GS being moved or displaced across the field of view of the local sensor LS.

In other words, the proposed system 1 can therefore be used to carry out a calibration or verification of the local coordinate measuring device LS by means of point pattern projection by the global coordinate measuring device GS, by evaluating the correspondence of the respective coordinates of the points C1-CN.

FIG. 2 shows a second embodiment of a surveying system 1′ according to the invention. In a manner differing from the previous embodiment, in this example a coordinate transformation from the local sensor LS by the global sensor GS takes place by a projection not onto the object surface 5 but rather onto a calibrated, active PSD-type (PSD=position sensitive detector) surface 6 of the local sensor LS. This PSD-type surface 6 is fixedly connected to the housing of the local sensor LS.

According to the invention, the global sensor GS, as previously described in connection with FIG. 1, detects the points G1-G4 in order to transform the GS coordinate system into the object coordinate system. The local sensor LS begins the surface measurement, for example via fringe projection, in the LS coordinate system. For the duration of the fringe projection data acquisition by the local sensor LS, for example 0.5-3 seconds, the global sensor GS measures the reference R1′-R4′ on the PSD-type surface 6 calibrated in the LS coordinate system, which surface is fixedly connected to the LS housing.

In addition to the fringe projection point cloud, the local sensor LS now also detects the discrete points R1′-R4′ on the PSD-type surface in the LS coordinate system. The PSD points and the point cloud thus exist in the LS coordinate system. In addition, by means of the known transformation of the reference system of the global sensor GS into the CO system of the object, the PSD points R1′-R4′ also exist in the object coordinate system. The LS measurement data can thus be displayed in the object coordinate system.

FIG. 3 shows a third embodiment of a surveying system 1″ according to the invention. In a manner differing from the previous embodiments, in this example a coordinate transformation from the local sensor LS by the global sensor GS takes place by a surveying of position-defined markings R1″-R4″, which are located on the housing of the local sensor LS, by the global sensor GS.

According to the invention, the global sensor GS as described above detects the points G1-G4 in order to transform the GS coordinate system into the object coordinate system. The local sensor LS begins the surface measurement, for example via fringe projection, in the LS coordinate system. During the fringe projection data acquisition by the local sensor LS, the global sensor GS now measures at least three points on a plurality of dimensionally stable markings calibrated in the LS coordinate system, which is connected to the LS housing in a positionally stable manner. To this end, the housing of the local sensor has for example, as shown, seven fixed points or point areas, and the global sensor measures at least three of these.

The point cloud generated by the local sensor exists in the LS coordinate system. The LS housing reference areas are detected by means of the global sensor GS and via the points G1-G4 in the object coordinate system. The LS data can thus be displayed in the object coordinate system.

FIG. 4 shows an embodiment of a surveying system 10 according to the invention for coordinatively surveying a target object 11, comprising a surveying device 12 and a laser pointer 20 which is held by a user 21 at some distance from the surveying device 11. The surveying device 11, which in the example is configured as a laser tracker, has a pedestal 15 and a support 14, the support 14 being arranged such as to be able to pivot or rotate relative to the pedestal, in particular in a motorized manner, about a pivot axis 13 defined by the pedestal 15. An aiming unit 19, which may be configured as a beam deflecting unit, is additionally arranged on the support 14 in such a way that the aiming unit 19 can pivot relative to the support 14, in particular in a motorized manner, about a tilt axis (transit axis). Since the beam deflecting unit 19 can thus be oriented about two axes, an aiming axis 22 can be oriented in a flexible manner and thus it is possible to aim at targets 11 and to determine, for example by means of laser radiation (not shown), the distance to a point on the target surface (for example by measuring the propagation time, by using the phase measurement principle, by WFD (waveform digitizing), by frequency comb laser radiation, by absolute interferometry and/or by using the Fizeau principle). In the example, the points to be surveyed are represented by retroreflectors 11a and 11b. By means of this distance measurement, the coordinates of the point 11a or 11b can thus be determined together with the measured aiming direction, said aiming direction being measured a protractor for example. Here, the pivot axis 12 and the tilt axis are substantially orthogonal to one another, that is to say minor deviations from an exact axis orthogonality can be determined beforehand and stored in the system, for example in order to compensate any resulting measurement errors.

For automatically orienting the aiming axis 22 towards a target 11 or one of the target points 11a, 11b, the laser tracker 12 has, as part of a target-seeking unit, illumination means 17 for divergently illuminating the target 11 with radiation 23 in the infrared wavelength range, and additionally at least one camera 18 with a position-sensitive detector, said camera having for example a field of view of 10°-15°. The illumination radiation 23 that is reflected by the target 11 or a reflector 11a, 11b back to the laser tracker 12 can be detected as a light spot in an image from the target detection camera 18 and a position of the target 11 on the position-sensitive detector can be imaged by the detector, said position being able to be determined as an image position of at least one light spot. Therefore, by means of a control and evaluation unit with a seeking functionality, which is provided in the laser tracker 12, a rough target position can be determined and, in a manner dependent thereon, the target 11 can be found and the beam deflecting unit 19 can be oriented towards the target 11. The aiming unit 19 additionally has an image recording unit 16, configured for example as a CCD or pixel sensor array (wide-angle ATR or overview) camera.

In the example, with the target axis 22 in the initial orientation, both reflectors 11a and 11b are illuminated with IR radiation 23 and are or would be detected by the target detection camera 18, so that it is unclear which of the two points 11a and 11b is to be surveyed. In order to avoid such ambiguity, the user 21 uses the laser pointer 20, which emits an IR beam 24 adapted to the wavelength sensitivity of the target detection camera 18, to mark the target point 11b that is to be surveyed. In order to make the orientation of the laser pointer 20 visible to the user, the laser pointer 20 simultaneously emits a visible laser beam 25 in the same direction.

In other words, the user 21 uses the infrared marker beam to mark the target point 11b that is to be surveyed. Since the IR radiation, for example having a wavelength of 860 nm, is visible to the target detection camera 18, the surveying device 12 thus identifies the location of the marking and can select and survey the desired reflector 11b. Compared to a likewise possible detection of (visible) laser pointer radiation by the image recording unit 16 for marking the target point, the marking of the target point by means of laser pointer IR radiation 24 and the target detection camera 18 offers the advantage of a greatly improved signal-to-noise ratio (SNR).

Preferably, the system 10 is configured such that the orientation of the beam deflecting unit 19 and of the aiming axis 22 can be changed by means of the laser pointer marking, whereby the beam deflecting unit 19 follows a movement of the marker beam 24 or 25. By moving the hand-held pointer 20 and following the device 12, it is even possible to move to a point outside of the instantaneous field of view of the target detection camera 18. If, as a result of changing the orientation of the beam deflecting unit 19, a reflector 11a or 11b then comes into the field of view of the target detection camera 18, said reflector will automatically be selected and aimed at.

To reduce or eliminate interference caused by ambient light, preferably the IR light 24 of the pointer 20 is modulated, for example in the form of pulses of a particular pulse frequency, so that marker light 24 can be distinguished from extraneous light. As an alternative or in addition, in parallel with the detection of the IR pointer beam 24 by the target detection camera 18, the visible pointer beam 25 is captured by the overview camera 16. To check for consistency, it is then ascertained whether the integrated visual overview camera 16 sees a laser pointer marking at the same location 11b. In other words, the optical camera 18 is used to verify whether corresponding positions can be ascertained for the infrared marking and the visible marking.

In the example, the laser pointer 20 and the surveying device 12 additionally have modules 27a and 27b for wireless communication, for example Bluetooth or WLAN modules. This is then used, for example, to inform the surveying device 12 automatically that the laser pointer 20 has been switched on, so as thus to trigger the ready-to-receive state of the surveying device 12 and specifically of the target detection camera 18. If the marked point 11b is then not in the field of view of the camera 18, it is then possible as an option to automatically initiate a search for the point marked by the laser pointer 20, by pivoting the aiming unit 19.

The laser pointer 20 in the example also has two operating buttons 26. In the example, one of the two buttons 26 is used to switch the pointer 20 on, so that the beams 24 and 25 are emitted and also, as described above, an activation command is sent wirelessly to the surveying device 12. When the other of the two buttons 26 is pressed, an additional command is transmitted to the surveying device 12, either likewise wirelessly or by modulating onto the IR beam 24 a specific pulse pattern that encodes said command. The pulse pattern therefore represents a defined command, which is known to the surveying device 12 as a result of being stored in a memory of the latter and thus can be read from the marker light 24 detected by the camera 18.

FIG. 5 shows a second exemplary embodiment of a surveying system 10 according to the invention. In the example, the surveying device 12′ of the system 10 is configured as a laser scanner, by which a large number of points on the surface of an object 11 can be surveyed and thus a 3D point cloud can be generated in a known manner. The laser scanner 12′ has a target detection camera 18, by which, as described above in connection with FIG. 4, the infrared marker light 24 of the laser pointer 20 guided by the user 21 can be detected.

In the example, the laser pointer 20 serves to mark a target area that is to be scanned by the laser scanner 12′. To this end, the IR beam 24 is aimed successively towards four corner points 29 of the object surface. In order to notify the surveying device 12′ when a corner point 29 is marked, in the example a small or rapid circle is “drawn” on the surface at the location of a respective corner point by swivelling (swivelling movement indicated by the arrow 20a). The meaning of this “small circle” symbol is stored in a memory of the surveying device 12′, so that the detected IR light representing the symbol will be “understood” by the surveying device 12′. In this way, the four corner points 29 are indicated to the surveying device 12′. As an alternative to such a communication by means of symbols, a marking of a corner point 29 is notified by pressing one of the operating buttons 26 or simply by holding the pointer 20 stationary at a corner point location for a certain period of time, for example 3 s or 5 s.

In FIG. 5, the symbol 31 is shown as a further example of using symbols for control purposes or to transmit information. To complete the marking of the target area 30 and initiate the surveying thereof, the user 21 uses his IR pointer 20 to “draw” a type of cross approximately in the centre of the target area 30. It is stored in the surveying device 12′ that the scan can start when this symbol 31 is identified or decoded. Alternatively, a command to start the scan takes place by means of one of the operating buttons 26 (for example by a long press on a button instead of a short press for marking a corner point) or the device 12′ starts automatically when no further corner point 29 has been marked for a certain period of time, for example after 30 s or one minute, and a target area 30 can be calculated on the basis of the marked corner points 29 (for example therefore at least three corner points 29 have been marked).

Optionally, before a scan is started as indicated in FIG. 5, a visual confirmation of the target area 30 by the surveying device 12′ takes place. To this end, the latter emits in a directional manner a light beam 29, which is visible to the user 21, and follows the boundaries of the target area 30 with this beam 29. The user 21 can thus check whether the surveying device 12′ has correctly “understood” his commands or whether he must mark the target area 30 again.

It will be understood that these illustrated figures schematically show only possible exemplary embodiments. The various approaches can also be combined with one another and also with devices or methods of the prior art.

1-19. (canceled)

20. A surveying system comprising:
a global coordinate measuring device having a global coordinate system; and
a local coordinate measuring device having a local coordinate system, wherein the local coordinate measuring device is configured to coordinatively survey a surface of an object so as to generate a plurality of surveyed surface points which exist in the local coordinate system;
wherein the global coordinate measuring device and the local coordinate measuring device are connected by means of a common control and evaluation unit,
wherein the control and evaluation unit has a coordinate transformation functionality, during the execution of which:
first transformation parameters for transforming the local coordinate system into the global coordinate system are determined, in that at least three reference points, the respective defined position of which is known to either the global or the local coordinate measuring device, and are surveyed by the respective other of the global or the local coordinate measuring device, and
second transformation parameters for transforming the global coordinate system into the object-side coordinate system are determined, in that the global coordinate measuring device surveys at least three support points, the respective defined position of which in the object-side coordinate system is known.

21. The surveying system according to claim 20, wherein the at least three reference points are projected by the global coordinate measuring device in a defined manner onto a surface and the projected reference points are surveyed by the local coordinate measuring device.

22. The surveying system according to claim 21, wherein the reference points are projected onto the object surface at the time of projection while the surveying of the object surface takes place simultaneously.

23. The surveying system according to claim 21, wherein the reference points are projected onto a position-sensitive optoelectronic detector of the local coordinate measuring device, in particular wherein the sensitive detector surface occupies substantially the surface area of one housing side of the local coordinate measuring device.

24. The surveying system according to claim 20, wherein the at least three reference points are defined points on the housing of the local coordinate measuring device and surveyed by the global coordinate measuring device.

25. The surveying system according to claim 20, wherein the markings are surveyed by means of a camera or by means of measurement radiation of the global coordinate measuring device.

26. The surveying system according to claim 20, wherein the control and evaluation unit has calibration functionality, during the execution of which a calibration of the local coordinate measuring device takes place on the basis of the reference points.

27. A surveying system comprising:
a surveying device configured to coordinatively survey a movable target using a target detection camera with a detector which is sensitive in a defined infrared wavelength range, wherein a direction to the target can be determined by means of the target detection camera on the basis of infrared radiation coming from the target; and
a laser pointer for visually marking the target or a target area with visible radiation,
wherein the laser pointer is configured to mark that target or the target area with radiation in the defined infrared wavelength range, so that reflected laser point radiation can be detected by the detector.

28. The surveying system according to claim 27, wherein the visible radiation and the infrared radiation are generated by a common laser source.

29. The surveying system according to claim 27, wherein the infrared radiation has a wavelength in the near infrared range.

30. The surveying system according to claim 27, wherein the infrared radiation is modulated with a first and a second modulation.

31. The surveying system according to claim 27, wherein the laser pointer has a communication transmitter and the surveying device has a corresponding communication receiver.

32. The surveying system according to claim 27, wherein the surveying system is configured to issue control commands to the surveying device by means of the infrared radiation.

33. The surveying system according to claim 27, wherein the surveying device has a light source for emitting a directional light beam, and the surveying device is configured such that a detection of a target area marked by the infrared radiation is visually confirmed by a user, whereby the surveying device marks using the visible light steel.

34. The surveying system according to claim 27, wherein the surveying device has an overview camera which is sensitive to the visible radiation of the laser pointer, and the surveying device is configured such that a verification of a position determined by the target detection camera and marked by the infrared radiation takes place on the basis of a position determined at the same point in time by the overview camera and marked by the visible radiation.

35. A method for controlling a surveying device which has a direction and distance measurement functionality, the method comprising:
emitting radiation in a desired infrared wavelength range towards a target using a laser pointer which is spatially separate from the surveying device;
determining a direction to the target on the basis of infrared radiation coming from the target using a target detection camera with a detector which is sensitive in a defined infrared wavelength range, said target detection camera being a component of the surveying device and being configured to determine a direction to the target on the basis of infrared radiation coming from the target; and
controlling the surveying device is controlled based on the radiation being detected by the surveying device by means of the target detection camera and evaluated on the basis of stored control command decoding information.

36. The method according to claim 35, wherein the controlling of the surveying device is performed based on pulse patterns of the infrared laser pointer radiation or by using the infrared radiation to project symbols onto a surface.

37. The method according to claim 35, wherein a change in orientation of an aiming axis of the surveying device takes place by means of the infrared laser pointer radiation.

38. A computer program product, which is stored on a machine-readable carrier or is embodied by an electromagnetic wave, for controlling or executing the method according to claim 35.
